(19) United States
(12) Patent Application Publication
(10) Pub. No.: US 2016/0170617 A1
(43) Pub. Date: Jun. 16, 2016

(54) AUTOMATIC ACTIVE REGION ZOOMING

(71) Applicant: Cisco Technology, Inc., San Jose, CA (US)

(72) Inventors: Qi Shi, Suzhou (CN); Hua Ouyang, Suzhou (CN); Huahua Yin, Suzhou (CN); Guoxin Zhou, Suzhou (CN); Yulin Chang, Saratoga, CA (US)

(21) Appl. No.: 14/567,975

(22) Filed: Dec. 11, 2014

(51) Int. Cl. G06F 3/0484; G06T 3/40

(52) U.S. Cl. CPC G06F 3/04845; G06T 3/40; G06F 2203/04806

(57) ABSTRACT

Methods and apparatus for automatically zooming content in an active region are provided. Embodiments of the system allow a user of a computing device to share content on a display element with a portable computing device. The portable computing device is configured to display the shared content on its display screen. By doing so, a plurality of factors can be identified to trigger automatic zooming, and a relevance value for determining automatic zooming is determined. Upon determining the relevance value for automatic zooming, the portable computing device can display automatically zoomed region on its screen. The automatically zoomed region can include zoomed content located in an active region, and the rest of the region outside of the active region can be zoomed out or disappeared from the screen.

### BACKGROUND

1. Technical Field

The present technology pertains to viewing content on computing devices. More particularly, the present disclosure relates to a method for automatically zooming in or out on a portion of the content displayed on a portable computing device.

2. Description of Related Art

With dramatic advances in communication technologies, the advent of new techniques and functions in portable computing devices has steadily aroused consumer interest. In addition, various approaches to online meeting sharing technology through user-interfaces have been introduced in the field of portable computing devices.

Many computing devices employ online meeting technology for sharing content on the display element of the computing device. Often, online meeting technology allows a host to share content on his or her computing device with other users through a wireless connection. It often requires a user with a portable computing device having a small display element to manually zoom in or out the relevant portion of the content, in order to view the content more clearly on the portable computing device, because the portable computing device will not have enough display area to show all the shared content in one screen and make the shared content readable by the user. Manually zooming in or out as the meeting progresses can be cumbersome to the user and it can hamper the user's concentration on the meeting.

### BRIEF DESCRIPTION OF THE DRAWINGS

In order to describe the manner in which the above-recited and other advantages and features of the disclosure can be obtained, a more specific description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A and 1B illustrate an example configuration of a computing device in accordance with various embodiments;

FIG. 2 illustrates a block diagram illustrating an example method for automatically zooming content on a computing device;

FIG. 3 illustrates an example interface layout that can be utilized on a computing device in accordance with various embodiments;

FIG. 4 illustrates an example interface layout that can be utilized on a computing device in accordance with various embodiments;

FIGS. 5A, 5B, 5C and 5D illustrate an example zoom screen interface layout that can be utilized on a computing device in accordance with various embodiments;

FIG. 6 illustrates an example zoom screen interface layout that can be utilized on a computing device in accordance with various embodiments; and

FIGS. 7A, 7B, 7C, 7D, and 7E illustrate an example triggering element score list that represents weight values used to determine automatic zooming.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some embodiments, computing devices employ online meeting technology for sharing content on the display element of the computing device. Often, online meeting technology allows a host (presenter) to share content on his or her computing device with other users of portable computing device (attendee). Content can be any graphic or audio visual content that can be displayed in the user interface such as a web interface, presentation, or meeting material. Often times, the portable computing device has a small screen element to display all the shared content properly. As such, a user of the portable computing device may have to manually zoom in or out on a relevant portion of the content to be displayed on the portable computing device screen. However, if the user was in a fast-paced meeting or meeting that requires high level of concentration, it may not be feasible or easy to zoom in or out a relevant portion of the content every time.

As such, the present technology is used for automatically zooming in or out the relevant content displayed on the screen of the portable computing device. This is accomplished, in part, through identifying a plurality of factors for triggering an automatic zoom-in operation or zoom-out operation, and computing a relevance value to determine such action. For example, the computing device is configured to compute each of the plurality of triggering factors for automatic zoom-in or zoom-out operation, and determine a relevance value for each of the computed factors. The relevance value indicates a level of interest/relevance in the current topic of the meeting material. The relevance value is a sum of a weighted score value of the each of the plurality of factors. The relevance value is compared with a threshold value for automatic zoom-in or zoom-out. Once the relevance value is determined to be higher than the threshold value for an automatic zoom-in operation, then a relevant portion of the audio-visual content can be automatically zoomed in. On the other hand, if the aggregate is determined to be lower than the threshold value for an automatic zoom-out operation, a relevant portion of the audio-visual content can be automatically zoomed-out.

The content in the active region is zoomed-in (magnified), when the content appears enlarged on the screen of the computing device. In this instance, the content can be magnified without any animation from zoom-out to zoom-in. On the other hand, the content in the active region is zoomed-out (compressed), when the content appear smaller than the original size of the content.

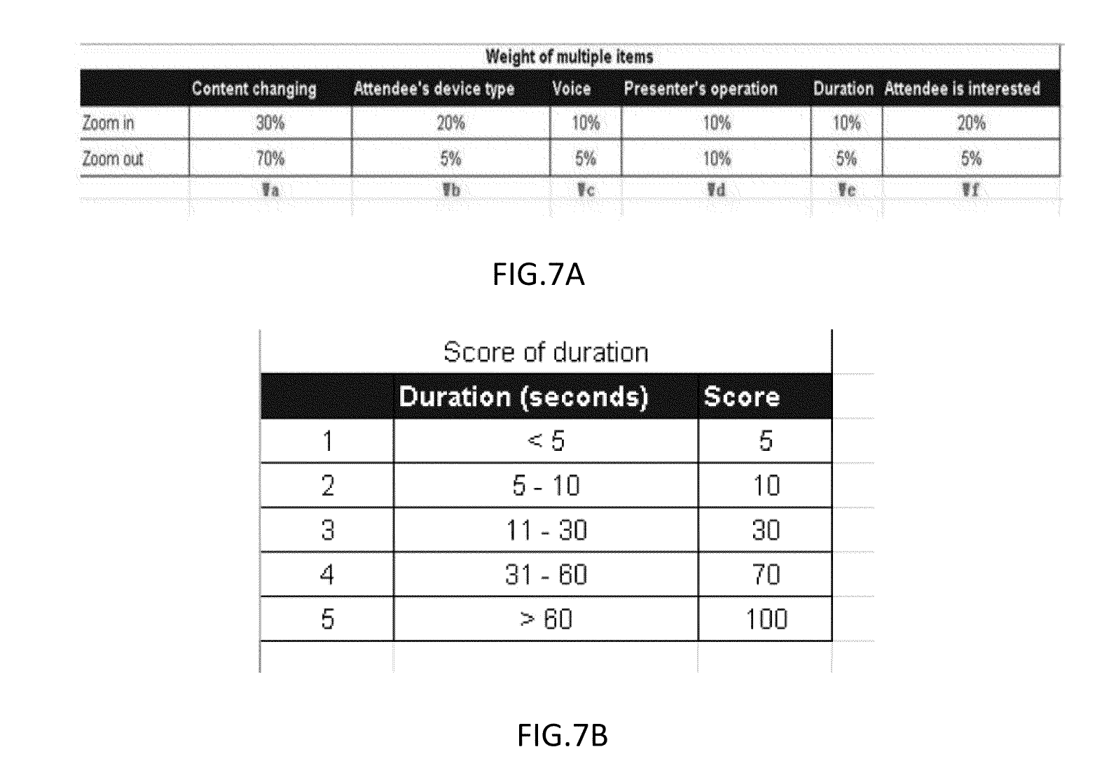

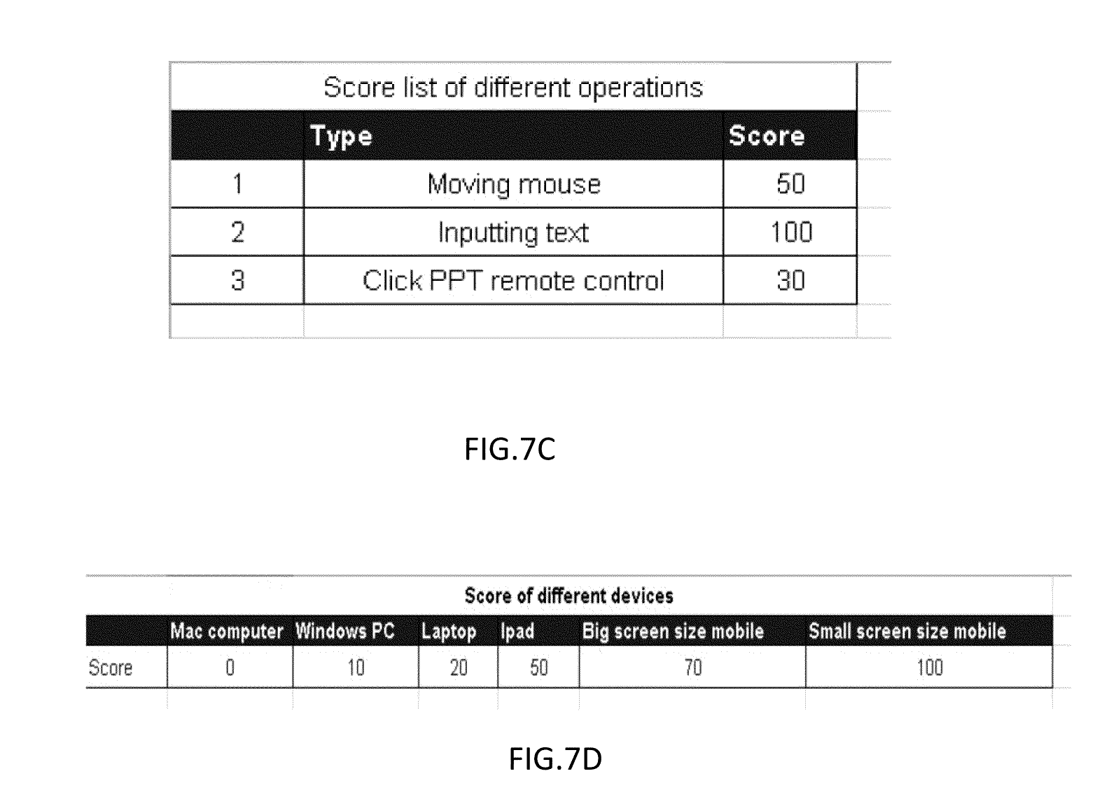

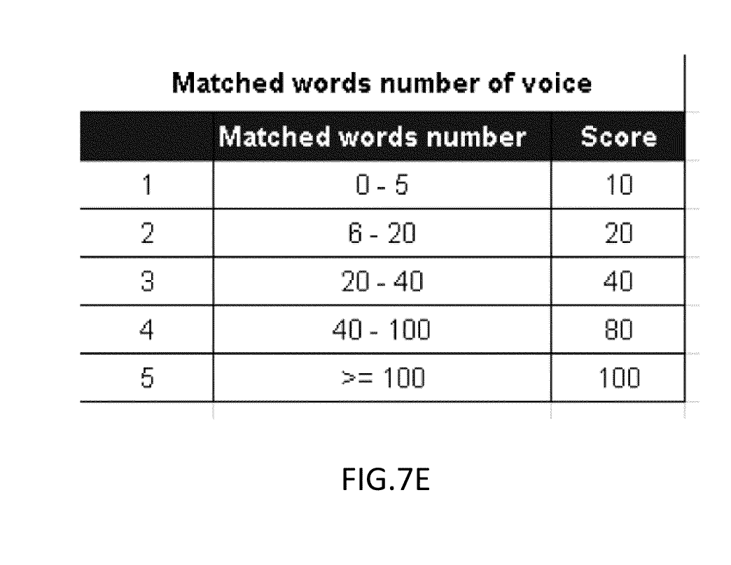

In some embodiments, a plurality of factors for triggering automatic zoom-in or zoom-out operation can include, but not limited to, detection of a changing region (region where content is changing) on the computer screen of the presenter's computing device, attendee's computing device type, voice recognition, presenter's operation, duration, relevancy to the content, and a screen size of the computing device, as illustrated in FIG. 7A.

In some embodiments, the computing device is configured to analyze coordinates of the active region (automatically zoomed region) on the computer screen to adjust zoomed region based on a content changing region on the presenter's computing device that is not displayed within the current zoomed region. The computing device can calculate a location and size of the currently content changing region using block coordinate address and determine which portion of the content needs to be zoomed in/out. In some embodiments, border padding on an edge of the active region can be utilized to yield more predictable zooming.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

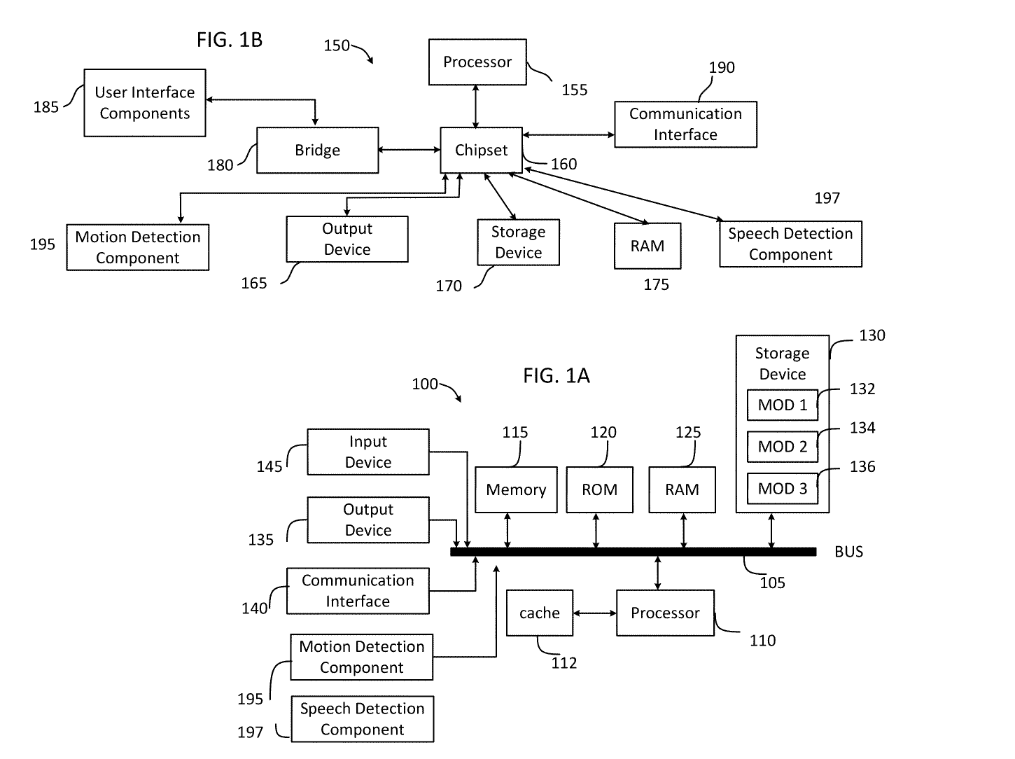

In order to provide various functionalities described herein, FIGS. 1A and 1B illustrate an example set of basic components of a portable computing device 100. Although a portable computing device (e.g. a smart phone, an e-book reader, personal data assistant, or tablet computer) is shown, it should be understood that various other types of electronic devices capable of processing input can be used in accordance with various embodiments discussed herein.

FIG. 1A and FIG. 1B illustrate an example configuration of system embodiments. The more appropriate embodiment will be apparent to those of ordinary skill in the art when practicing the present technology. Persons of ordinary skill in the art will also readily appreciate that other system embodiments are possible.

FIG. 1A illustrates conventional system bus computing system architecture 100, wherein the components of the system are in electrical communication with each other using a bus 105. Example system embodiment 100 includes a processing unit (CPU or processor) 110 and a system bus 105 that couples various system components, including the system memory 115 such as read only memory (ROM) 120 and random access memory (RAM) 125 to the processor 110. The system 100 can include a cache of high-speed memory connected directly with, in close proximity to, or integrated as part of the processor 110. The system 100 can copy data from the memory 115 and/or the storage device 130 to the cache 112 for quick access by the processor 110. In this way, the cache can provide a performance boost that avoids processor 110 delays while waiting for data. These and other modules can control or be configured to control the processor 110 to perform various actions. Other system memory 115 may be available for use, as well. The memory 115 can include multiple different types of memory with different performance characteristics. The processor 110 can include any general purpose processor and a hardware module or software module—such as module 1 132, module 2 134, and module 3 136 stored in storage device 130, configured to control the processor 110, as well as a special-purpose processor where software instructions are incorporated into the actual processor design. The processor 110 may essentially be a completely self-contained computing system, containing multiple cores or processors, a bus, memory controller, cache, etc. A multi-core processor may be symmetric or asymmetric.

To enable user interaction with the computing device 100, an input device 145 can represent any number of input mechanisms, such as: a microphone for speech, a touch-sensitive screen for gesture or graphical input, keyboard, mouse, motion input, speech and so forth. An output device 135 can also be one or more of a number of output mechanisms known to those of skill in the art. In some instances, multimodal systems can enable a user to provide multiple types of input to communicate with the computing device 100. The communications interface 140 can generally govern and manage the user input and system output. There is no restriction on operating on any particular hardware arrangement and therefore the basic features here may easily be substituted for improved hardware or firmware arrangements as they are developed.

Storage device 130 is a non-volatile memory and can be a hard disk or other types of computer readable media, which can store data that are accessible by a computer, such as: magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules are contemplated. The storage device 130 can be connected to the system bus 105. In one aspect, a hardware module that performs a particular function can include the software component stored in a computer-readable medium in connection with the necessary hardware components—such as the processor 110, bus 105, display 135, and so forth to carry out the function.

In some embodiments the device will include at least one motion detection component 195, such as: electronic gyroscope, accelerometer, inertial sensor, or electronic compass. These components provide information about an orientation of the device, acceleration of the device, and/or information about rotation of the device. The processor 110 utilizes information from the motion detection component 195 to determine an orientation and a movement of the device in accordance with various embodiments. Methods for detecting the movement of the device are well known in the art and as such will not be discussed in detail herein.

In some embodiments, the device can include speech detection component 197 which can be used to recognize user speech. For example, the voice detection components can include: speaker, microphone, video converters, signal transmitter and so on. The voice components can process detected user voice, translate the spoken words, and compare with text in the meeting material. The typical audio files include: mp3 files, WAV files, or WMV files. It should be understood that various other types of speech recognition technologies are capable of recognizing user speech or voice in accordance with various embodiments discussed herein.

FIG. 1B illustrates a computer system 150 as having a chipset architecture that can be used in executing the described method and generating and displaying a graphical user interface (GUI). Computer system 150 is an example of computer hardware, software, and firmware that can be used to implement the disclosed technology. System 150 can include a processor 155, representative of any number of physically and/or logically distinct resources capable of executing software, firmware, and hardware configured to perform identified computations. Processor 155 can communicate with a chipset 160 that can control input to and output from processor 155. In this example, chipset 160 outputs information to output 165, such as a display, and can read and write information to storage device 170, which can include magnetic media, and solid state media, for example. Chipset 160 can also read data from, and write data to, RAM 175. A bridge 180 for interfacing with a variety of user interface components 185 can be provided for interfacing with chipset 160. Such user interface components 185 can include the following: keyboard, a microphone, touch detection and processing circuitry, a pointing device, such as a mouse, and so on. In general, inputs to system 150 can come from any of a variety of sources, machine generated and/or human generated.

Chipset 160 can also interface with one or more communication interfaces 190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 155 analyzing data stored in storage 170 or 175. Further, the machine can receive inputs from a user, via user interface components 185, and execute appropriate functions, such as browsing functions, by interpreting these inputs using processor 155.

The motion detection component 195 is configured to detect and capture the movements by using a gyroscope, accelerometer, or inertial sensor. Various factors such as a speed, acceleration, duration, distance or angle are considered when detecting movements of the device. It can be appreciated that example system embodiments 100 and 150 can have more than one processor 110, or be part of a group or cluster of computing devices networked together to provide greater processing capability.

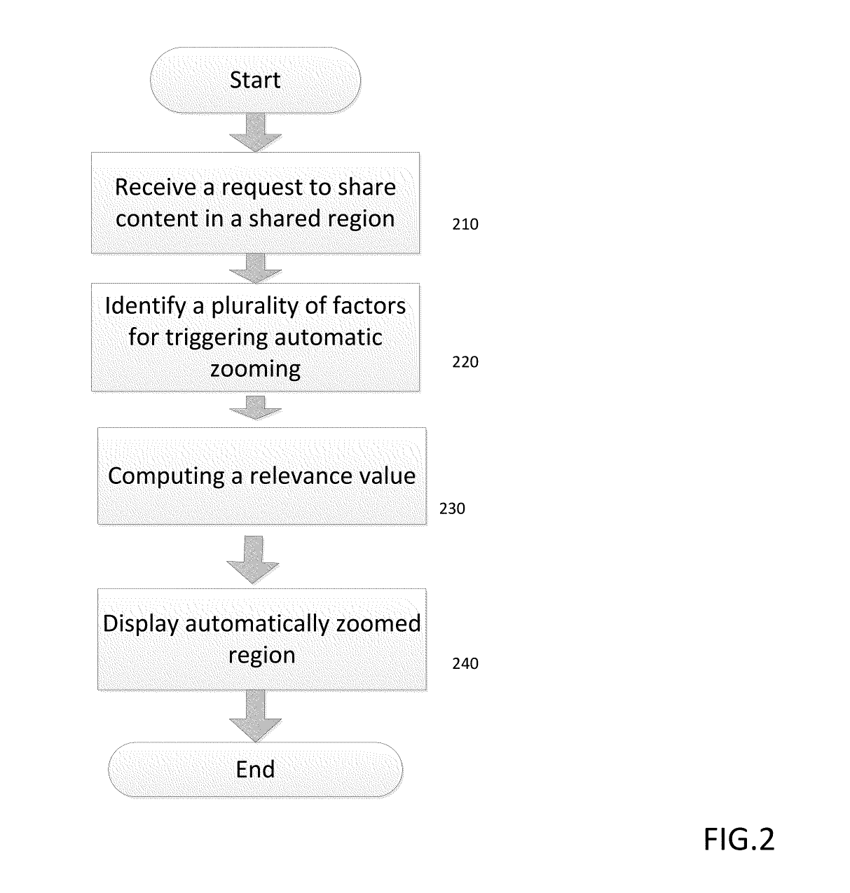

FIG. 2 illustrates an example process 200 for automatically zooming content on a computing device in accordance with various embodiments. It should be understood that, for any process discussed herein, there can be additional or alternative steps performed in similar or alternative orders, or in parallel, within the scope of the various embodiments unless otherwise stated. In some embodiments, a computing device (presenter) is configured to send a request to share content displayed in the user interface with another computing device (attendee) 210. Content can be any audio-visual or graphic content that can be displayed in the user interface such as power point slides, excel spread sheets, web interface, or audio-visual content. The attendee's device can receive the request and can determine whether to accept the request to allow the presenter's computing device to share the content with the attendee's computing device. Often times, the portable computing device (attendee) cannot display all the content in one screen pan-optically, as the portable computing device often has a small display screen. As such, the portable computing device is configured to automatically zoom a relevant portion of the content to be displayed upon a user selecting an option to do so.

Upon selecting an option to automatically zoom relevant portion, the computing device is configured to identify a plurality of factors that trigger automatic zooming, such as detecting changing regions/blocks, presenter's voice/speech recognition, duration, attendee's computing device type, presenter's operation, or attendee's interests in the content 220. It should be understood that, the list is not exhaustive and there can be additional or alternative factors which can be considered in determining the automatic zooming. Each of the plurality of factors are assigned different score values to be used to calculate the relevance value for triggering automatic zooming. The relevance value indicates a level of interest of the user in the current topic in the meeting material. The relevance value is the most relevant content/topic that is currently being focused during the meeting. The relevance value is an aggregated value that includes all the weighted score value of the each of the plurality of factors. The score values are weighted differently based on a level of importance of each factor in determining automatic zooming operation. Upon calculating the relevance value and comparing this value with a threshold value for automatic zoom-in/out 230, the computing device can display an automatically zoomed region 240. The plurality of factors includes at least one of duration, time, speech recognition, type of input on the first computing device, and a detection of a changing region, as indicated in FIG. 7A.

If the relevance value is higher than the threshold value for the automatic zoom-in, then the active region can be automatically magnified (zoomed-in). Once the active region is automatically magnified, then the rest of the region outside the active region can be either automatically zoomed-out or disappeared from the full screen depending on the screen size and the portable computing device type. In some embodiments, if the relevance value is lower than the threshold value for the automatic zoom-out, then the active region can be zoomed-out and the rest of the region outside the active region can be automatically zoomed-in or appeared on the full screen.

The threshold value for automatic zoom in/out can be predetermined by a portable computing device. The portable computing device can consider a plurality of factors to determine the threshold value for a particular type of portable computing device, such as a screen size of the portable computing device, a mobile type, or detection of changing block.

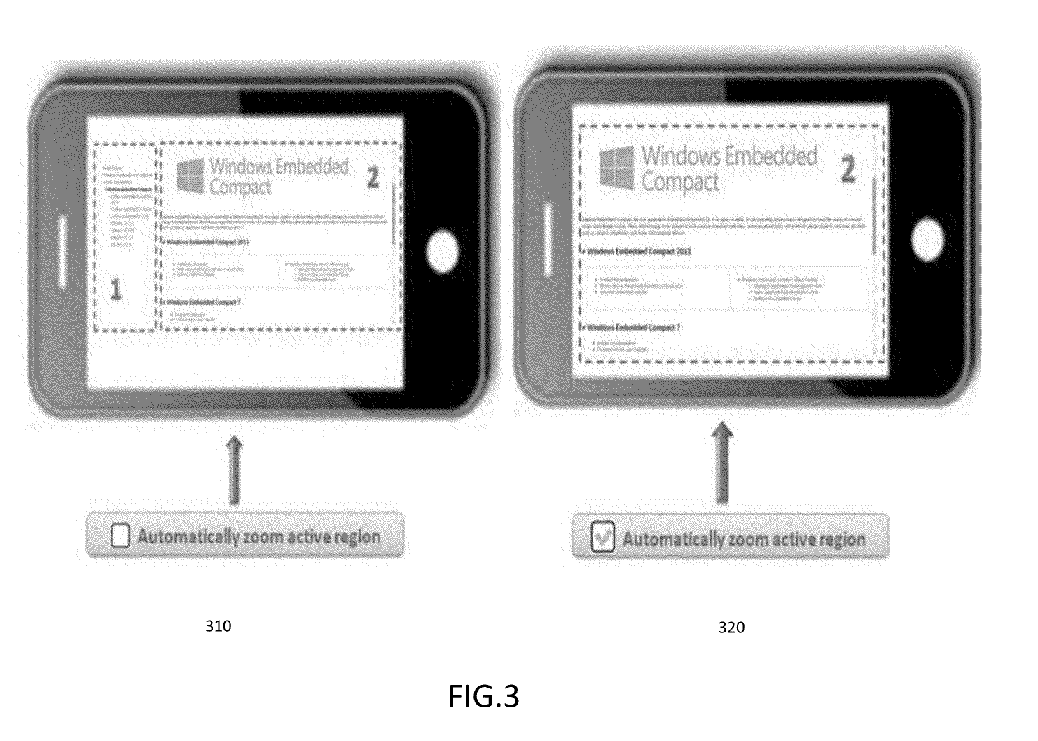

FIG. 3 illustrates an example interface page 310, 320 that might be presented to a user in accordance with various embodiments. In this example, the user can select an option to automatically zoom active region when needed. As illustrated in 320, upon selecting the option to automatically zoom an active region, the active region calculated based upon the triggering factors will be zoomed and a relevant portion of the content (window 2) will be displayed on the full screen of the portable computing device. On the other hand, if the automatically zoom active region option is unchecked, then the graphical user interface will display fully presented area from the presenter's computing device on the attendee's portable computing device and will remain in a normal display mode (window 1 and window 2), as illustrated in 310.

In some embodiments, when the active region is determined in the portable computing device (attendee's device), the portable computing device can share the coordinates of the active region with the computing device (presenter's device). The presenter's computing device can display the active region of the attendee's portable computing device with a dotted line to indicate the active region (interested region) on the attendee's portable computing device. For example, on the full screen of the presenter's computing device, a border line can be shown in a dotted line so the presenter can distinguish the active region (zoomed region) and non-active region (not-zoomed region), thus, the presenter can identify the region that is currently being zoomed for a consistent progress of the meeting.

In some embodiments, an active region can include just content portion and not include a substantial portion of any menu item or window item. For example, if the meeting material is a youtube video and the user is only interested in watching the content portion (video portion), then the menu items next to the content portion may not be included in the active region. In some embodiments, the active region can include not only the content portion, but also the menu or window frame. For example, if the meeting material is a web interface, then the user can select the window item (address bar) to be included in the active region, if the address bar is an important item to be included for display. The active region can be automatically chosen by default as it can be pre-determined by a computing device. In some embodiments, a user can also select an active region by manually selecting a certain portion of content that needs to be included in the active region.

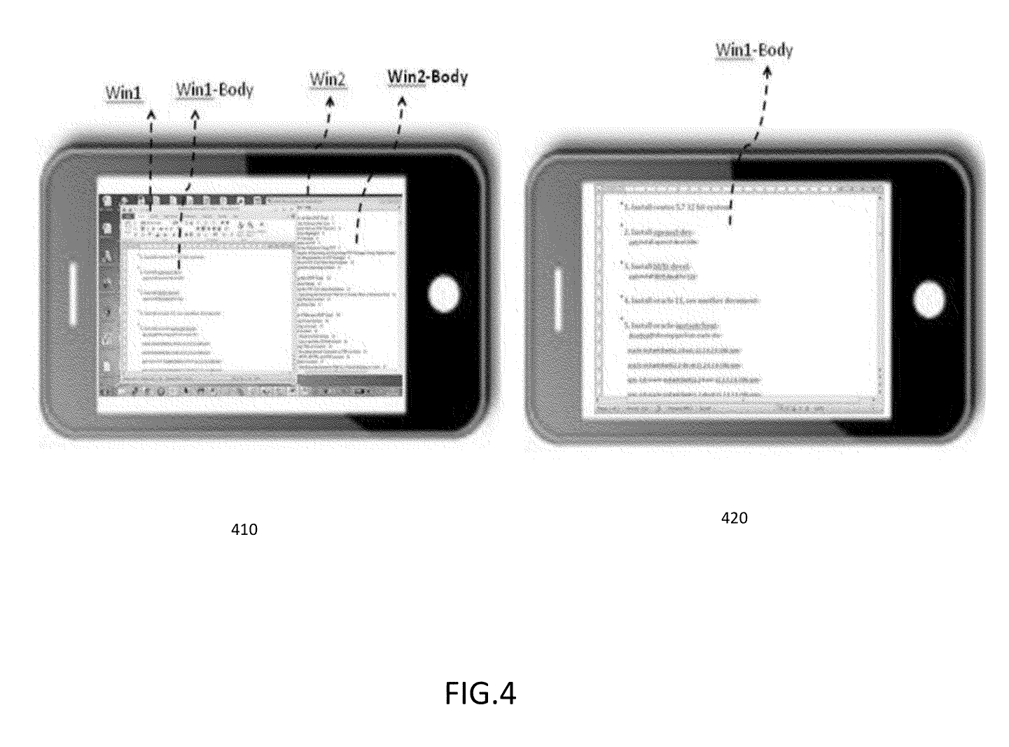

FIG. 4 illustrates an example interface page 410, 420 that might be presented to a user accessing an electronic graphical user interface using a computing device which is able to send and receive electronic communications over a network. The presenter's computing device 410 and the attendee's computing device 420 are remotely connected over network such as internet. Although the portable computing device (attendee) 420 may display only win1-body on the display screen upon selecting the “automatically zoom the active region” option, the computing device (presenter) 410 may display all the content displayed in full screen including win1 body in Win1 frame and Win2 body in Win2 frame, as illustrated in 420 of FIG. 4.

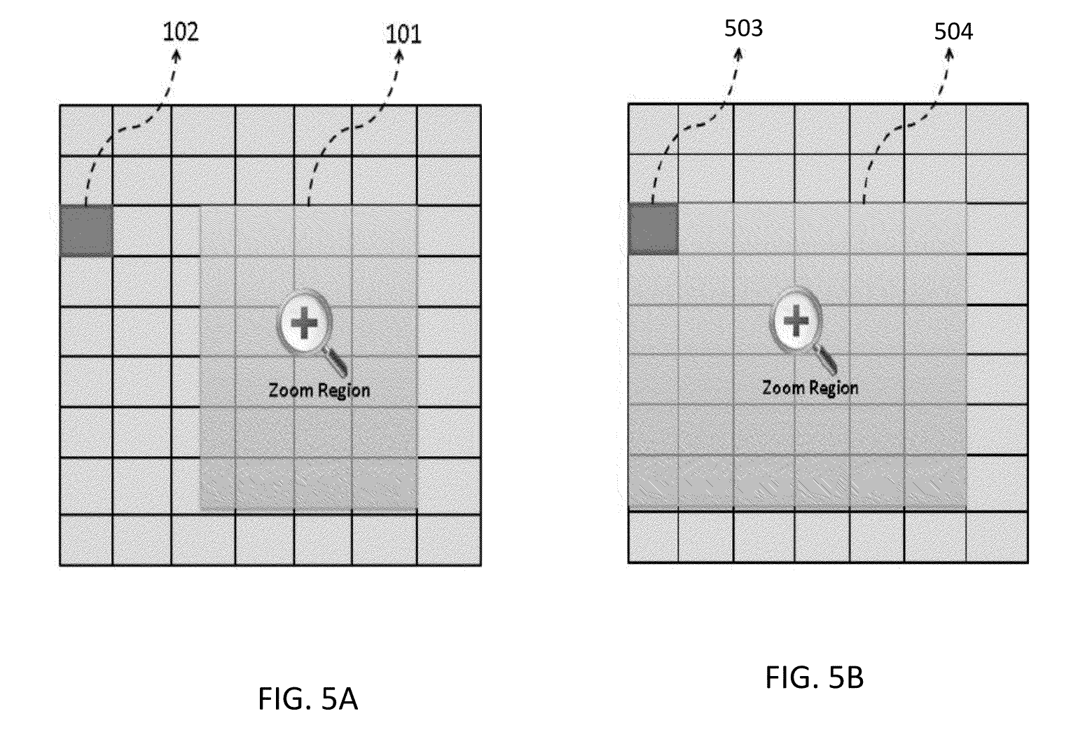

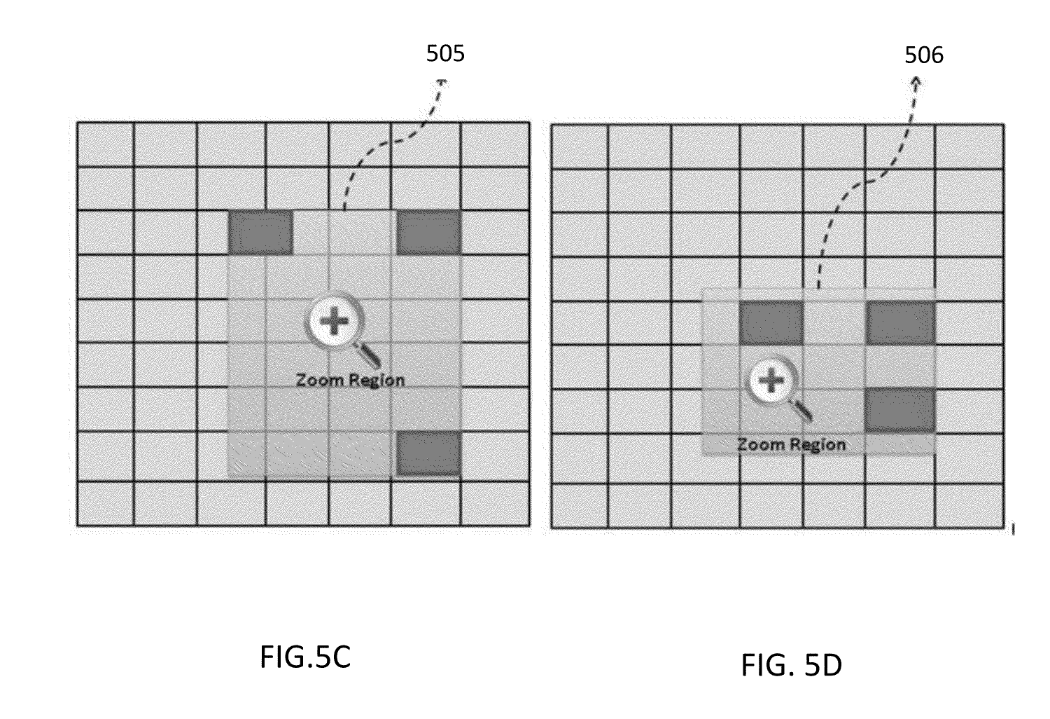

FIGS. 5A, 5B, 5C and 5D illustrate an example zoom screen interface layout that can be utilized on a computing device in accordance with various embodiments. A full screen of the presenter's computing device screen is divided by a set of blocks that can be represented as a grid. In FIG. 5A, 101 indicates a currently zoomed region (active region), and 102 indicates a changing region where the content within the changing region is being changed in the presenter's device. Content changing can be made from any type of input methods such as moving a mouse, inputting text, or clicking power point slides with a remote controller. An example list of possible list of input methods is illustrated in FIG. 7C. Each of the input methods has different weight values assigned which corresponds to the importance of each input method. For example, inserting a text in the meeting material can be considered an important task, if there is a good point that is made during the meeting. Moving a mouse to a different region can also be considered an important task to show that the focus is changing to a different content in a different region. It should be understood that, while a score list of different input method values are shown in the FIG. 7C, any input method can be part of the input operation which triggers automatic zooming, and the score values for each of the input methods can be different from the score list in FIG. 7C.

As illustrated by FIG. 5A, while only a zoomed region (active region) 101 is being displayed on an attendee's device, content within a block 102 outside the active region (changing region) 102 may be refreshed/changed. When it is determined that the relevance value is higher than a threshold value for automatic zoom-in, then a new set of blocks including the changing region 503 will be part of a new automatically zoomed-in active region 504, along with the original active region 101, resulting a bigger active region 504 as shown in FIG. 5B. Like this, active regions can be either enlarged or shrunk, producing a re-sized active region.

As shown in FIG. 5C and FIG. 5D, as an area of the changing block becomes narrow from 505 in FIG. 5C to 506 in FIG. 5D, the computing device is configured to resize the active region to show a more accurate zoomed region as needed. For example, each of the changing block 550 is located further away from the other changing block 550 in FIG. 5C than the changing blocks 560 in FIG. 5D. When it is detected that the changing blocks are getting closer to each other as shown in FIG. 5D, then the zoomed region will shrink only to include the shrunken changing region accordingly.

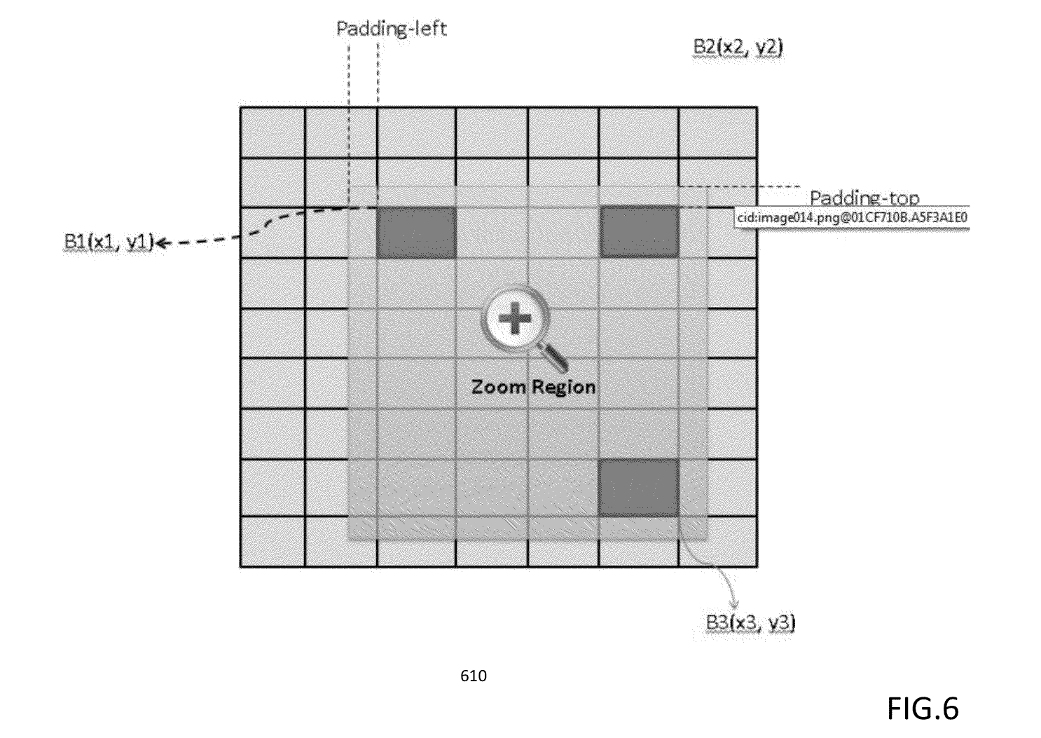

FIG. 6 illustrates an example zoom screen interface layout that can be utilized on a computing device in accordance with various embodiments. In some embodiments, border padding can be placed at the edge of the zoomed active region to improve the user experience and display effect. The border padding can be placed on the top, bottom, left, and right section of the active region, and the content in the border padding section is also zoomed along with the active region. The padding can work as a buffer between the zoomed active region and rest of the non-zoomed region, and thus, the entire active region can be protected from being unnecessarily left out of the zoomed region and cropped. By having the border padding around the active region, all the content in the active region can be displayed zoomed with enough margins around edges of the active region. The padding size can be configured in system settings. The default value can be 3% of the active region width.

In some embodiments, the border padding can be represented by longitudinal (y-axis) or latitudinal (x-axis) coordinates as indicated in FIG. 6. For example, if a left top side of the active region's coordinates are represented by x-coordinate and y-coordinate such as B3(x1, y1), then the left top side of the border padding's coordinates can be represented by a new coordinate such as B4(x1+width of the border padding left, y1+width of the border padding top). Border padding left or border padding top can be the same width, resulting the active region to be radially expanded.

FIGS. 7A, 7B, 7C, 7D, and 7E illustrate an example triggering element score list that represents weight values used to determine automatic zooming. As illustrated in FIG. 7A, a plurality of factors for triggering automatic zoom-in/out are introduced. It should be understood that, while factors are shown, any factors can be part of the triggering elements, and the weight distribution among the triggering elements can be different. When the system considers multiple items such as content changing blocks (content is being changed/refreshed), attendee's device type, voice/speech detection, presenter's operation, duration, or attendee's interests in the content being presented on the screen.

As illustrated in FIG. 7A, relevance values for zoom-in or out can be calculated accordingly. In this formula, Zoom-in=(Content Change*Wa+Device Type*Wb+Voice Match*Wc+Presenter Operation*Wd+Duration*We+Attendee Interested*Wf). Zoom-out=(Content Change*Wa+Device Type*Wb+Voice Match*Wc+Presenter Operation*Wd+Duration*We+(100−Attendee Interested)*Wf). Wa, Wb, Wc, Wd, and We represents weight values based on an importance of each factors under multiple conditions.

In some embodiments the presence of trigger is enough to change the zoom area as shown in the following formula:

IsTrigger=Obc∥(Ms && Time)∥Vo

In this formula, “Obc” represents changing blocks located outside the active region, “Ms” represents a presenter's computer mouse moving status, “Time” represents the time the presenter's mouse moves and “Vo” represents a presenter's voice for “voice to text” technology. In such embodiments, if any of the events identified in the formula are satisfied, the zoomed area will adjust to include the area where the event is occurring. For example, if blocks of pixels are changing outside the current zoomed area, the zoomed area will adjust to include those blocks. Likewise, if the presenter's mouse is moved outside the current zoomed area for a long enough period of time (e.g., greater than 1 second), the zoomed area will adjust to include the region of the screen where the mouse is located. Likewise, if a voice-to-text technology is enabled, the system can match text that the presenter is speaking with text on the screen, and if such a match is determined to take place on a region of the screen outside the zoomed area, the currently zoomed area can adjust to include the text on the screen that approximately matches the words the presenter is speaking.

As indicated in the above formula, the presence of trigger can change the active area, and can change the zoomed region. In some embodiments, the active region can be designated by a user of the presenter's computing device by manually magnifying a certain portion of the content in the presenter's computing device. The active region can also be chosen by detecting a changing region outside the currently zoom area. In some embodiments, the active region can be chosen by detecting a number of matched spoken words within the content presented on the presenter's computing device. The active region can be chosen by considering above identified factors.

In some embodiments, content changing can be one factor to consider when determining automatic zooming. If the presenter is typing or deleting texts during the meeting, that content is likely to be a main content to be discussed at that time. Thus, it is desirable to zoom-in that portion of the content as the presenter is changing the content on the meeting material. Similarly, if the content in certain region is being refreshed, then the score value can be close to 100. For example, the content in an audio-visual content region such as a video file are refreshed every second, because the frames for the audio-visual content are being replaced and changed every second. On the other hand, the score value can be 0 when there is no content changing or refreshing.

In some embodiments, a presenter's voice is another element to consider when determining an automatic zooming. As known in the art for “Voice to text” technology, the presenter's voice can be recognized and analyzed to match the text. If the presenter is reading the paragraphs off the screen and the voice recognition component finds a matched text region in the meeting material displayed on the screen, then the system will calculate the score values according to the above formula to determine the automatic zoom-in operation. Upon detecting 0-3 matching words, as illustrated in FIG. 7A, the system will give 10% weight distribution on the voice recognition element. Likewise, if there are more than 10 matched words, then 80% weight will be distributed on the voice recognition element. Weight values can be different based on the number of matched words as that illustrates an importance of the text being matched and analyzed. As there are more matched words recognized by the voice recognition component, the system will assign more weight values depending on the matched word range as illustrated in FIG. 7E. FIG. 7E are just an example list of the matched word range list and it should not be limited to these described numbers.

In some embodiments, attendee's computing device can be one of a plurality of factors to determine the automatic zooming. For example, as illustrated in FIG. 7D, each of the different devices can have corresponding score values depending on a size of the display screen. In this example, a MAC computer or window PC are assigned lower score values than the mobile devices, because the display screen for the MAC computer or WINDOW PC desktop computer are relatively larger than screen of mobile devices. As such, there is less need in zooming the content on the MAC computer or WINDOW PC desktop computer, because the content on the display screen of MAC computer or WINDOW PC desktop computer are less likely to impacted. On the other hand, mobile devices regardless of the size of the display screen have relatively high weight values distributed, because there is a limitation to the screen size of the mobile devices and often times, they are a lot smaller than the MAC computer or WINDOW PC desktop, thus, there is more need to automatic zoom in those devices to view the content more clearly.

In some embodiments, duration can be one of a plurality of factors to consider when determining automatic zooming. If any operation occurs such as receiving any input device event, then the system will not likely consider triggering automatic zoom-in. On other hand, if operation does not occur, then the system will likely to consider trigger the automatic zoom-in operation. Different score values are assigned to a different duration range, and score values will be substituted and calculated into the above formula.

In some embodiments, attendee's interest in the current content can be one of a plurality of factors to consider when determining automatic zooming operation. Attendee's interest can be determined in various ways: face detection, eye contact, or inattentive attendee's computer status. In one example, motion detection movement can detect gaze point of the attendee or distance between the face of the attendee and the computing device to determine whether the attendee is interested in the current content. In some embodiments, facial expression detection can be another method to determine attendee's interests in the current content. For example, if the system detects that the attendee is frowning while looking at the content on the display screen, it may determine that the attendee is not interested. Detecting an attendee's computer status can be another example of determining attendee's interests in the current content. If the attendee's computer is being idle for a considerable amount of time, then the system will likely to determine that the attendee is not interested in the current content. If it is determined that the attendee is interested in the current content, then the score value can be 100, whereas if it is determined that the attendee is not interested in the current content, then the score value can be 0.

In one embodiment, the presenter's computing device can invite a plurality of portable computing devices (attendees) into a meeting and share the same content with the plurality of invited attendee's devices. Each of the attendee's devices can be a different type of device from one another with respect to the screen size and mobile device type. Thus, when one attendee's device determines the active region to zoom certain portion of the presenter's content on its screen based on its device type, another attendee's device will have its own determination based at least in part on the screen size and the mobile device type. Thus, active region on one attendees' device can be different from an active region on other attendee's device. As such, automatic zooming operation on one attendee's device does not impact other attendee's device.

For clarity of explanation, in some instances the present technology may be presented as including individual functional blocks, including: functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as: energy, carrier signals, electromagnetic waves, and signals per se.

Methods according to the above-described examples can be implemented using computer-executable instructions that are stored or otherwise available from computer-readable media. Such instructions can include, for example, instructions and data which cause or otherwise configure a general purpose computer, special purpose computer, or special purpose processing device to perform a certain function or group of functions. Portions of computer resources used can be accessible over a network. The computer-executable instructions may be, for example: binaries, intermediate format instructions such as assembly language, firmware, or source code. Examples of computer-readable media that may be used to store instructions, information used, and/or information created during methods according to described examples include: magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include: laptops, smart phones, small form factor personal computers, personal digital assistants, and so on. Functionality described herein can also be embodied in peripherals or add-in cards. Such functionality can also be implemented on a circuit board among different chips or different processes executed by in a single device, by way of further example.

The instructions, media for conveying such instructions, computing resources for executing them, and other structures for supporting such computing resources are means for providing the functions described in these disclosures.

Although a variety of examples and other information were used to explain aspects within the scope of the appended claims, no limitation of the claims should be implied based on particular features or arrangements in such examples, as one of ordinary skill would be able to use these examples to derive a wide variety of implementations. Furthermore, although some subject matter may have been described in language specific to examples of structural features and/or method steps, it is to be understood that the subject matter defined in the appended claims is not necessarily limited to these described features or acts. For example, such functionality can be distributed differently, or performed in components other than those identified herein. Rather, the described features and steps are disclosed as examples of components of systems and methods within the scope of the appended claims.

1. A computer-implemented method comprising:
displaying graphic content on a display of a first computing device;
receiving a request, at the first computing device, to automatically zoom the graphic content on the display of the first computing device;
determining an active region of the graphic content in the first computing device; and
zooming-in on the active region of the graphic content in the first computing device.

2. The computer-implemented method of claim 1, wherein the active region is determined to be a content portion of a single displayed window, excluding a substantial portion of any menu items or window frames.

3. The computer-implemented method of claim 1, wherein the active region is repeatedly determined.

4. The computer-implemented method of claim 3, wherein the active region is dynamically adjusted when a trigger is detected outside a current active region, the trigger being indicative that content of interest is outside the current active region.

5. The computer-implemented method of claim 4, wherein the trigger is a changing block of pixels within the graphic content that are not displayed on the display of the first computing device.

6. The computer-implemented method of claim 4, wherein the graphic content is a presentation being shared from a second computing device, and the trigger is a received indication that a mouse of the second computing device has been outside of the current active region for a predetermined period of time.

7. The computer-implemented method of claim 4, wherein the graphic content is a presentation, and the method further comprises:
comparing text of a presenter's speech with written text within the graphic content; and
determining that the written text being referred to by the presenter is outside the current active region.

8. The computer-implemented method of claim 6, further comprising:
determining a relevance value to a portion of the graphic content, the relevance value indicates a real-time level of interest of a user in the graphic content in a shared content, the relevance value is based at least in part on a plurality of factors used for determining the active region; and
in response to determining that the relevance value is higher than a threshold value, designating the portion of the graphic content as the active region.

9. A system for automatically zooming content to be displayed in an electronic environment, comprising:
a processor;
a memory device including instructions that, when executed by the processor, enables a computing device to:
receive a request, at a first computing device, to share content, the content is shared with a second computing device;
display the content on the first computing device;
determine a relevance value of the content, the relevance value indicates a real-time level of interest in the content, the relevance value is based at least in part on a plurality of factors used for determining the automatic zooming; and
in response to determining that the relevance value is higher than a threshold value for the automatic zooming, magnify the content on the first computing device.

10. The system of claim 9, wherein the instructions when executed by the processor, further enables the computing device to:
in response to determining that the relevance value is lower than a threshold value for automatic zoom-out, zoom-out the content on the first computing device.

11. The system of claim 9, wherein the second computing device is configured to share the content with a plurality of computing devices, wherein each of the plurality of computing devices are configured to zoom the content respectively at least based on a display screen size of the each of the computing devices.

12. The system of claim 9, wherein the first computing device having a display screen smaller than a display screen of the second computing device.

13. A non-transitory computer-readable storage medium storing instructions for automatically zooming graphic content on a computing device, when executed by a processor of the computing device, causes the computing device to:
display graphic content on a display of a first computing device;
receive a request, at the first computing device, to automatically zoom the graphic content on the display of the first computing device;
determine an active region of the graphic content in the first computing device; and
magnify the active region of the graphic content in the first computing device.

14. The non-transitory computer-readable storage medium of claim 13, wherein the active region is dynamically adjusted when a trigger is detected outside a current active region, the trigger being indicative that content of interest is outside the current active region.

15. The non-transitory computer-readable storage medium of claim 13, wherein the graphic content is a presentation being shared from a second computing device, a trigger is a received indication that a portion of the presentation is being magnified by a user of the second computing device.

16. The non-transitory computer-readable storage medium of claim 13, wherein the graphic content is the presentation being shared from the second computing device, the trigger is a received indication that text is being inserted in the presentation that is outside of the current active region on the second computing device.

17. The non-transitory computer-readable storage medium of claim 13, wherein the trigger includes at least one of a duration, time, speech recognition, type of input on the second computing device, and a detection of a changing block of pixels within the graphic content that are not displayed on the display of the first computing device.

18. The non-transitory computer-readable storage medium of claim 13, wherein the active region includes a layer of block of pixels around the automatically zoomed region, the content in the layer of block are automatically magnified in the first computing device.

19. The non-transitory computer-readable storage medium of claim 13, further comprising:
in response to magnifying the active region of the graphic content in the first computing device, zooming-out the graphic content outside of the active region in the first computing device.

20. The non-transitory computer-readable storage medium of claim 13, wherein the first computing device and the second computing device are remotely connected.
